(19) United States
(12) Patent Application Publication
(10) Pub. No.: US 2021/0004747 A1
(43) Pub. Date: Jan. 7, 2021

(54) INFORMATION PROCESSING DEVICE, INFORMATION PROCESSING METHOD, AND PROGRAM

(71) Applicant: SONY CORPORATION, TOKYO (JP)

(72) Inventors: NORIHIRO TAKAHASHI, TOKYO (JP); SATOSHI SUZUNO, TOKYO (JP)

(21) Appl. No.: 16/977,014

(22) PCT Filed: Jan. 9, 2019
(86) PCT No.: PCT/JP2019/000395

§ 371 Date: Aug. 31, 2020

(30) Foreign Application Priority Data
Mar. 9, 2018 (JP) 2018-042566

(51) Int. Cl. G06Q 10/06

(52) U.S. Cl. CPC G06Q 10/06316; G06Q 10/063114; G06Q 10/06315

(57) ABSTRACT

An information processing device includes a control unit that determines a recommended action to be presented to a user being present in a predetermined place, the recommended action being determined on the basis of a context of the user and information regarding a time at which an away user heading for the place is expected to arrive at the place.

### TECHNICAL FIELD

The present disclosure relates to an information processing device, an information processing method, and a program.

### BACKGROUND ART

A device that provides action support to the user is known. For example, Patent Document 1 listed below describes a device that presents a destination or route in accordance with the user's situation.

### CITATION LIST

### Patent Document

Patent Document 1: Japanese Patent Application Laid-Open No. 2017-26568

### SUMMARY OF THE INVENTION

### Problems to be Solved by the Invention

In such field, it is desired to present an appropriate action to the user on the basis of appropriate information.

An object of the present disclosure is to provide an information processing device, an information processing method, and a program capable of determining, for example, an action to be performed next by the user on the basis of appropriate information.

### Solutions to Problems

The present disclosure is, for example,

an information processing device including:

a control unit that determines a recommended action to be presented to a user being present in a predetermined place, the recommended action being determined on the basis of a first context of the user and a second context of an away user, the second context including information regarding a time at which the away user heading for the place is expected to arrive at the place.

The present disclosure is, for example,

an information processing method including:

determining a recommended action to be presented to a user being present in a predetermined place, the recommended action being determined on the basis of a first context of the user and a second context of an away user, the second context including information regarding a time at which the away user heading for the place is expected to arrive at the place, the determining being performed by a control unit.

The present disclosure is, for example,

a program causing a computer to execute an information processing method, the information processing method including:

determining a recommended action to be presented to a user being present in a predetermined place, the recommended action being determined on the basis of a first context of the user and a second context of an away user, the second context including information regarding a time at which the away user heading for the place is expected to arrive at the place, the determining being performed by a control unit.

### Effects of the Invention

According to at least an embodiment of the present disclosure, an action to be performed next by the user can be determined on the basis of appropriate information. Note that the effect described above is not restrictive, and any of effects described in the present disclosure may be included. Furthermore, the contents of the present disclosure are not to be construed as being limited by the illustrated effects.

### BRIEF DESCRIPTION OF DRAWINGS

FIG. 1 is a block diagram illustrating an example configuration of an information processing system according to one embodiment.

FIG. 2 is a diagram for explaining action information according to one embodiment.

FIG. 3 is a diagram for explaining a specific example of the action information according to one embodiment.

FIG. 4 is a diagram for explaining a specific example of the action information according to one embodiment.

FIG. 5 is a diagram for explaining a specific example of the action information according to one embodiment.

FIG. 6 is a diagram for explaining a specific example of a search condition (query) according to one embodiment.

FIG. 7 is a diagram illustrating a specific example of the action information according to one embodiment.

FIG. 8 is a diagram illustrating a specific example of the action information according to one embodiment.

FIG. 9 is a diagram illustrating a specific example of the action information according to one embodiment.

FIG. 10 is a flowchart showing a process flow for updating the action information according to one embodiment.

FIG. 11 is a flowchart showing a process flow for updating the action information according to one embodiment on the basis of information obtained from an external apparatus.

FIG. 12 is a flowchart showing a process flow for outputting a recommended action according to one embodiment.

FIG. 13 is a flowchart showing a process flow for updating the action information according to one embodiment in accordance with an action performed in response to a recommended action.

FIG. 14 is a diagram illustrating an example of a displayed recommended action according to one embodiment.

FIG. 15 is a diagram illustrating an example (another example) of a displayed recommended action according to one embodiment.

FIG. 16 is a diagram illustrating an example (another example) of a displayed recommended action according to one embodiment.

FIG. 17 is a diagram illustrating an example (another example) of a displayed recommended action according to an embodiment.

FIG. 18 is a block diagram illustrating an example configuration of an information processing system according to a modification.

FIG. 19 is a block diagram illustrating an example configuration of an information processing system according to a modification.

### MODE FOR CARRYING OUT THE INVENTION

An embodiment and the like of the present disclosure will now be described with reference to the drawings. Note that descriptions will be provided in the order mentioned below.

<1. One embodiment>

<2. Modifications>

An embodiment and the like described below are specific preferred examples of the present disclosure, and the contents of the present disclosure are not limited to the embodiment and the like.

### 1. One Embodiment

[Example Configuration of Information Processing System]

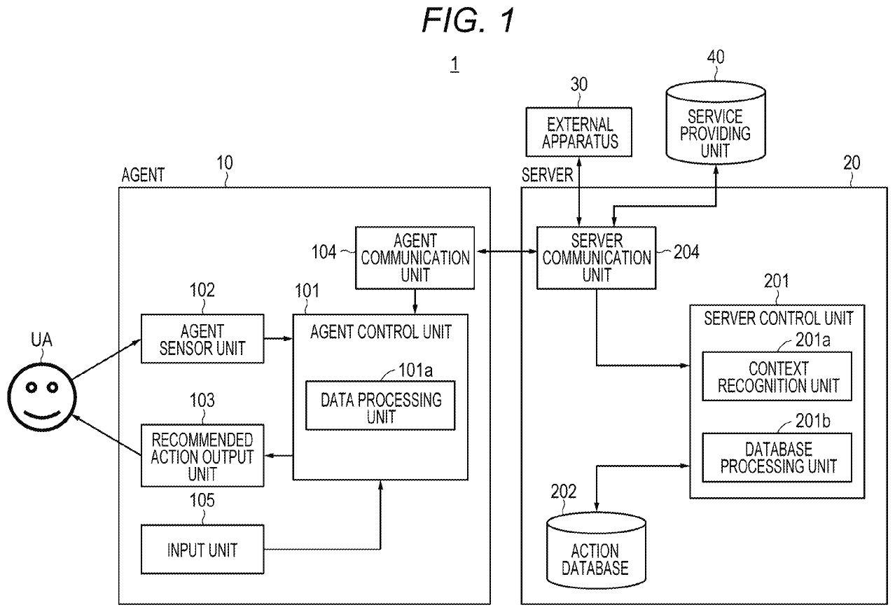

FIG. 1 is a block diagram illustrating an example configuration of an information processing system (information processing system 1) according to the present embodiment. The information processing system 1 includes an agent 10, a server device 20, which is an example of an information processing device, an external apparatus 30, which is a device different from the agent 10, and a service providing device 40.

(About Agent)

The agent 10 is, for example, an apparatus that is small enough to be portable and is placed in a house (indoors). As a matter of course, the user of the agent 10 can determine as appropriate where the agent 10 is placed, and the size of the agent 10 may not necessarily be small.

The agent 10 includes, for example, an agent control unit 101, an agent sensor unit 102, a recommended action output unit 103, an agent communication unit 104, and an input unit 105.

The agent control unit 101 includes, for example, a central processing unit (CPU) to control the individual units of the agent 10. The agent control unit 101 includes a read only memory (ROM) in which a program is stored and a random access memory (RAM) to be used as a work memory when the program is executed (note that their illustrations are omitted).

The agent control unit 101 includes a data processing unit 101a as a function of the agent control unit 101. The data processing unit 101a carries out processes including a process of performing A (analog)/D (digital) conversion on the sensing data supplied from the agent sensor unit 102, a process of converting the sensing data into data in a predetermined format, and a process of detecting whether or not the user is present in the home by using the image data supplied from the agent sensor unit 102.

Note that a user who is detected being in the home is referred to as a user UA as appropriate. There may be a single user UA or a plurality of users UA. On the other hand, an away user in the present embodiment refers to a user who is heading for the home from the outside of the home, that is, a user who is in the action of returning home. An away user is hereinafter referred to as an away user UB as appropriate. Depending on the family structure, there may also be a plurality of away users UB.

The agent sensor unit 102 is a predetermined sensor device. In the present embodiment, the agent sensor unit 102 is an imaging device capable of capturing an image of the inside of the home. The agent sensor unit 102 may include a single imaging device or a plurality of imaging devices. Furthermore, the imaging device may be separated from the agent 10, and image data obtained by the imaging device may be transmitted and received through communication between the imaging device and the agent 10. Furthermore, the agent sensor unit 102 may be a unit that senses a user who is present in a place (for example, a living room) where family members often gather in the home.

The recommended action output unit 103 outputs a recommended action to the user UA, and may be, for example, a display unit. Note that the display unit according to the present embodiment may be a display that is included in the agent 10 or a projector that displays the display contents on a predetermined place such as a wall, or may be anything else as long as displaying is used as a method for communicating information. Note that a recommended action in the present embodiment is an action (including the time to perform the action) recommended to the user UA.

The agent communication unit 104 communicates with another device connected via a network such as the Internet. The agent communication unit 104 communicates with, for example, the server device 20, and includes a modulation/demodulation circuit, an antenna, and the like that are compliant with a communication standard.

The input unit 105 receives an operation input from a user. The input unit 105 may be, for example, a button, a lever, a switch, a touch panel, a microphone, or a line-of-sight detection device. The input unit 105 generates an operation signal in accordance with an input made to the input unit 105, and supplies the operation signal to the agent control unit 101. The agent control unit 101 performs a process in accordance with the operation signal.

Note that the agent 10 may be configured to be driven on the basis of the electric power supplied from a commercial power source, or may be configured to be driven on the basis of the electric power supplied from a lithium-ion secondary battery or the like that can be charged and discharged.

(About Server Device)

The following describes an example configuration of the server device 20. The server device 20 includes a server control unit 201, an action database (hereinafter referred to as an action DB as appropriate) 202, which is an example of a storage unit, and a server communication unit 204.

The server control unit 201 includes a CPU and the like to control the individual units of the server device 20. The server control unit 201 includes a ROM in which a program is stored and a RAM to be used as a work memory when the program is executed (note that their illustrations are omitted).

The server control unit 201 includes, as its functions, a context recognition unit 201a and a database processing unit 201b. The context recognition unit 201a recognizes a context of each of the user UA and the away user UB. Furthermore, the context recognition unit 201a recognizes a context on the basis of information supplied from the external apparatus 30 or the service providing device 40. Note that a context is an idea encompassing a state and situation. The context recognition unit 201a outputs data indicating the recognized context to the database processing unit 201b.

The database processing unit 201b performs processing on the action DB 202. For example, the database processing unit 201b determines which information is to be written to the action DB 202 and writes the information to the action DB 202. Furthermore, the database processing unit 201b generates a query representing a search condition, on the basis of the context supplied from the context recognition unit 201a. Then, on the basis of the generated query, the database processing unit 201b retrieves and identifies a recommended action to be presented to the user UA from the action information stored in the action DB 202.

The action DB 202 is, for example, a storage device including a hard disk. The action DB 202 stores data pieces corresponding to a plurality of respective action information pieces. Note that the action information will be described later in detail.

The server communication unit 204 communicates with another device connected via a network such as the Internet. The server communication unit 204 according to the present embodiment communicates with, for example, the agent 10, the external apparatus 30, and the service providing device 40, and includes a modulation/demodulation circuit, an antenna, and the like that are compliant with a communication standard.

(About External Apparatus)

The external apparatus 30 is, for example, a portable device such as a smartphone owned by each user, a personal computer, an apparatus connected to a network (the so-called Internet of things (IoT) apparatus), or the like. The data corresponding to the information supplied from the external apparatus 30 is received by the server communication unit 204.

(About Service Providing Device)

The service providing device 40 is a device that provides various types of information. The data corresponding to the information supplied by the service providing device 40 is received by the server communication unit 204. Examples of the information provided by the service providing device 40 include traffic information, weather information, information about living, and the like. The information may be provided with or without charge. Examples of the service providing device 40 also include a device that provides various types of information via a home page.

[Example of Context]

The following describes examples of a context recognized by the context recognition unit 201a.

(1) Example of context relating to user UA (first context) (for example, determination is made on the basis of information acquired by the agent sensor unit 102)

. . . The context (idea) includes the presence in the home of any member (a person corresponding to the user UA) of a family. Furthermore, the context may include the fatigue level, stress, emotion, and the like of the user UA acquired on the basis of a process in which a known method is applied to images obtained by the agent sensor unit 102. In addition, in a case where the agent sensor unit 102 is capable of speech recognition, the context may include thoughts or intentions of the user UA based on the utterances of the user UA (for example, a specific meal desired). The context may include information based on an electronic schedule (scheduler).

(2) Example of Context Relating to Away User UB (Second Context)

. . . The context includes at least information about the time when the away user UB is expected to arrive at the home (estimated time of returning home). The context may include the current location, place (such as company, school, or lesson), or the like of the away user UB. The context may include information about the place at which the user made, or is making, a stop on the way home on the basis of position information, or may include information based on the use of electronic money, the contents of a message, and the like. The context may include information based on an electronic schedule (scheduler).

(3) Other Contexts (Example of Third Context)

. . . The context includes, for example, the information about regions around the home as supplied by the service providing device 40, such as weather information, traffic information, open or closed state of nearby stores, information about delay of trains, store business hours, and municipal office service hours.

[About Example Operation]

The following describes example operations in outline of the information processing system 1. The agent sensor unit 102 captures images on, for example, a periodic basis. The image data acquired by the agent sensor unit 102 is subjected to appropriate image processing, and then supplied to the data processing unit 101a of the agent control unit 101. The data processing unit 101a detects whether or not a person is present in the image data obtained through the imaging, on the basis of processing such as face recognition or contour recognition. Then, when a person is detected, the data processing unit 101a performs template matching using the person and the images registered in advance, and determines whether or not the person present in the home is a member of the family and which member is the person. Note that the process of recognizing a person may be performed on the server device 20 side.

When the user UA is detected, the agent control unit 101 controls the agent communication unit 104 to transmit, to the server device 20, information indicating that the user UA has been detected and who the user UA is. For ease of understanding, the description here assumes that the user UA is mother. The data transmitted from the agent 10 is received by the server communication unit 204, and then supplied to the server control unit 201. The context recognition unit 201a of the server control unit 201 recognizes the context of the mother that the user UA is the mother and the mother is present in the home, and outputs the recognition result to the database processing unit 201b. In addition, the context recognition unit 201a recognizes, as the context of the away user UB, the time when the away user UB is expected to return home, and outputs the recognition result to the database processing unit 201b. The database processing unit 201b generates a query based on the contexts supplied from the context recognition unit 201a, and, on the basis of the query, retrieves an action to be recommended to the mother from the action DB 202.

The server control unit 201 transmits the search result provided by the database processing unit 201b to the agent 10 via the server communication unit 204. The agent control unit 101 processes the search result received by the agent communication unit 104 and outputs the processing result to the recommended action output unit 103. The search result retrieved by the server device 20 is presented to the mother as a recommended action via the recommended action output unit 103. Note that although it is desirable that the mother performs the recommended action as presented, if there is an action having a higher priority than the recommended action, the mother may not necessarily perform an action corresponding to the recommended action.

In general, there are various actions performed in the home, such as household chores and things to do in order to enjoy leisure time. The optimal times to perform those actions are different depending on the purpose, such as when the other family members are absent, immediately before the family members come home, or when the family members are present. It is often impossible to perform these actions efficiently because it is necessary to plan actions while grasping schedules of family members in order to do these actions in a planned manner. However, according to the present embodiment, since an action in line with the contexts of the user and family members is planned, extracted, and recommended, an action to be performed in the home, for example, can be performed at the optimal timing. As a result, the user can spend more time in leisure, and feels more comfortable living at home.

[Specific Example of Recommended Action]

Here, in order to help understand the present disclosure with ease, specific examples of a recommended action are described along with outlined processes.

### Specific Example 1

On 2017/12/01/at 17:00, on the basis of the sensing result provided by the agent sensor unit 102, the server control unit 201 recognizes the mother's context: the mother has returned home and is in the home.

On the basis of the position information regarding each of the smartphones owned by family members (for example, father, mother, brother, and sister constituting four members) and their usual times to return home, the server control unit 201 predicts that the father will return home at 18:00, the brother will return home at 20:00, and the sister will return home at 19:30, thereby recognizing the contexts of the family members other than the mother. On the basis of the context of the mother and the contexts of the family members other than the mother, the database processing unit 201b generates a query and, on the basis of the query, retrieves, as a recommended action, the action “discuss Christmas gifts”, which is the action information registered in advance about an action that is to be performed by the father and mother only, requires 90 minutes, and is to be finished by 12/24, and also retrieves the action time 18:00 to 19:30.

The recommended action output unit 103 in the agent 10 presents the search result, which is a recommended action, to the mother. In addition, the database processing unit 201b retrieves, as a recommended action for 18:00 to 19:00, the action “buy toilet paper”, which is the action information registered in advance about an action to be performed by any member by 19:00. The search result is transmitted from the server device 20 to the agent 10. Then, the recommended action output unit 103 presents the recommended action to the mother.

### Specific Example 2

On 2017/12/01/at 17:00, on the basis of the sensing result provided by the agent sensor unit 102, the server control unit 201 recognizes the mother's context: the mother has returned home and is in the home. Furthermore, on the basis of the sensing result provided by the agent sensor unit 102, the server control unit 201 recognizes the respective contexts of the brother and the sister: the brother and the sister have returned home and are in the home.

On the basis of the position information regarding the smartphone owned by the father and his usual times to return home, the server control unit 201 predicts the context of the father that the father is expected to return home at 21:00. On the basis of these contexts, the database processing unit 201b generates a query and, on the basis of the query, retrieves, as a recommended action, starting by 19:20 the action “buy materials of cake”, an action that is to be performed by the mother and sister by 20:00 and requires 20 minutes, followed by starting by 21:00 the action “start making cake”, an action that is to be performed by the mother and sister and requires 80 minutes, where the action information regarding these actions is registered in advance. The search result is transmitted from the server device 20 to the agent 10. Then, the recommended action output unit 103 presents the recommended actions to the mother and the sister.

As described above, a recommended action is presented to the user UA present in the home.

[About Action Information]

(Example of Action Information)

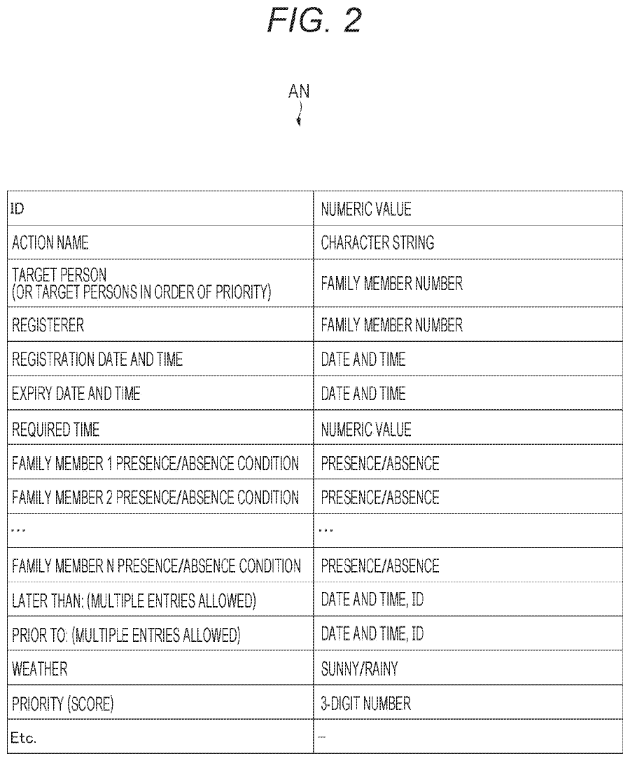

The following describes the action information stored in the action DB 202. FIG. 2 shows action information AN, which is an example of the action information. The action information AN includes, for example, a plurality of action attributes. A single action attribute includes an item or condition representing an attribute and specific data associated with the item or condition. For example, the action information AN shown in FIG. 2 includes: an action attribute including an identifier (ID) and its corresponding numerical data; an action attribute including an action name and its corresponding character string data; an action attribute including a target person (or target persons listed in order of priority) and data indicating family member number(s) corresponding to the target person(s); an action attribute including a presence/absence condition of family member 1 and data corresponding to the presence or absence; an action attribute including information indicating a chronological relationship with other action information (prior to, later than) and its corresponding data such as date and time or ID; and an action attribute including a priority (score) and its corresponding data, where the priority is used to determine which action information is to be presented as a recommended action when a plurality of action information pieces is retrieved. Note that the IDs are assigned, for example, in the order of registration of action information pieces.

Note that the action information AN shown in FIG. 2 is an example and is not restrictive. For example, some of the illustrated action attributes may be omitted, or other action attributes may be added. Some of the plurality of action attributes may be essential while other action attributes may be optional. Furthermore, there may be an action attribute to which data corresponding to an action attribute item is not set.

The action information AN is updated by, for example, inputting data corresponding to each action attribute item through user operations. Note that the term “update” in the present embodiment may refer to newly registering action information or may refer to changing the contents of the action information already registered.

The action information AN may be updated automatically. For example, the database processing unit 201b of the server control unit 201 automatically updates the action information AN on the basis of information from an external apparatus (at least one of the external apparatus 30 and the service providing device 40 in the present embodiment) obtained through the server communication unit 204.

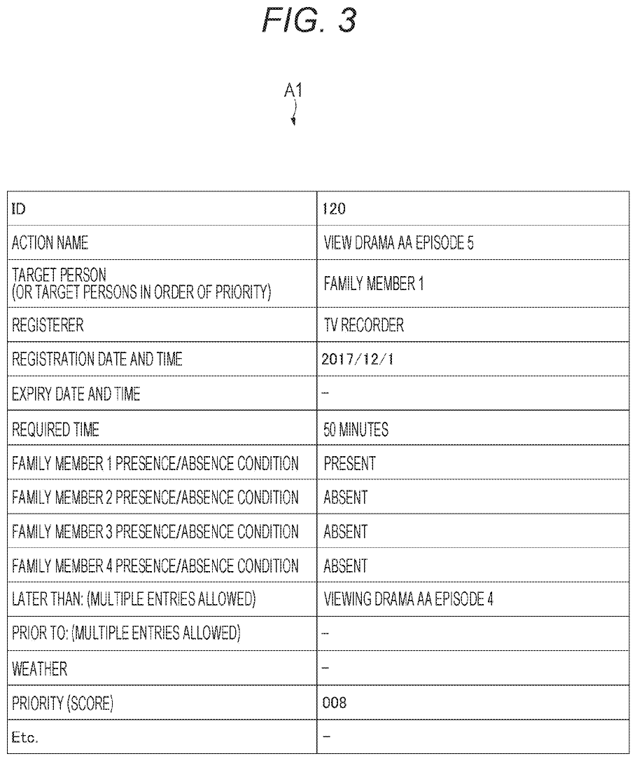

FIG. 3 shows the action information (action information A1) registered on the basis of information obtained from the external apparatus 30. The external apparatus 30 in the present example is, for example, a recorder capable of recording a television broadcast. For example, a television broadcast wave for television broadcasting includes “program exchange metadata” and “broadcast time” written in Extensible Markup Language (XML) format. The recorder uses such data to generate an electronic program table and interpret the user's recordings. For example, when the father (family member 1) performs an operation of programming the recorder to record the drama AA episode 5, the recordings including the recording user are supplied from the recorder to the server device 20.

The server control unit 201 acquires the recordings from the recorder via the server communication unit 204. The database processing unit 201b registers in the action DB 202 the action information A1 corresponding to the recordings acquired from the recorder. The server control unit 201 makes settings not only by simply registering the recordings but also by modifying, as appropriate, the recordings so as to be associated with action attributes or by determining a presumably applicable action attribute. For example, if the father programmed the recorder to record the drama AA episode 5, the server control unit 201 sets an action attribute with the condition that a recommended action is to be presented after the drama AA episode 4, which is the previous episode, is viewed, as an action attribute having the condition that an action of viewing the drama AA episode 5 is presented as a recommended action.

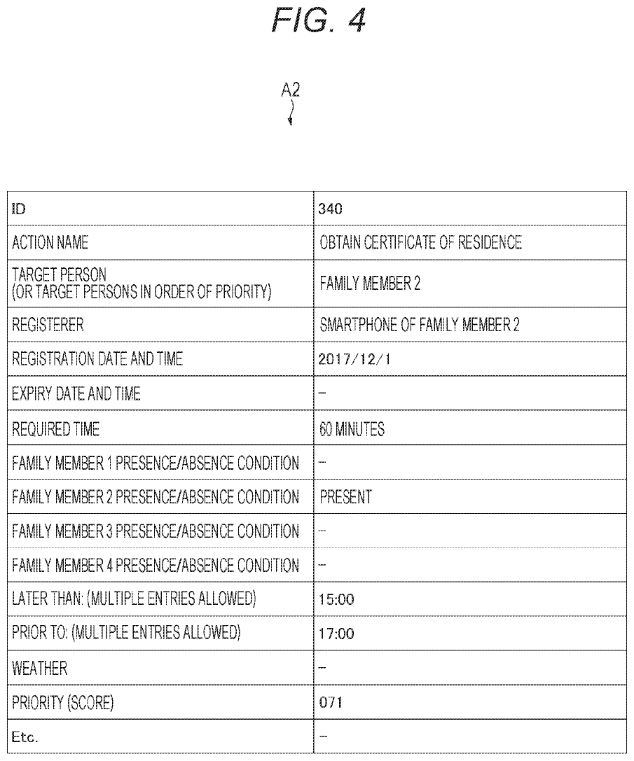

FIG. 4 shows the action information (action information A2) registered on the basis of the information obtained from the external apparatus 30 and the service providing device 40. The external apparatus 30 in the present example is, for example, the smartphone owned by the mother, who is a family member 2. It is assumed that an application for managing a schedule is installed on the smartphone. The server device 20 acquires, via the server communication unit 204, the contents of the mother's schedule set on the smartphone. For example, obtaining a certificate of residence is recognized by the server device 20 as the contents of the mother's schedule. Furthermore, the server device 20 accesses the homepage of the ward office in the district where the mother resides to acquire information about the location of the ward office and the service hours when the certificate of residence can be obtained.

The server control unit 201 sets the required time to obtain the certificate of residence on the basis of locations on the way from the home to the ward office, how crowded the ward office is, and the like. Furthermore, the server control unit 201 sets the time to obtain the certificate of residence on the basis of the information regarding the time periods when the mother has few other things to do and the hours when the certificate of residence can be obtained. Then, the database processing unit 201b writes the settings into the action DB 202, whereby the action information A2 as illustrated in FIG. 4 is registered.

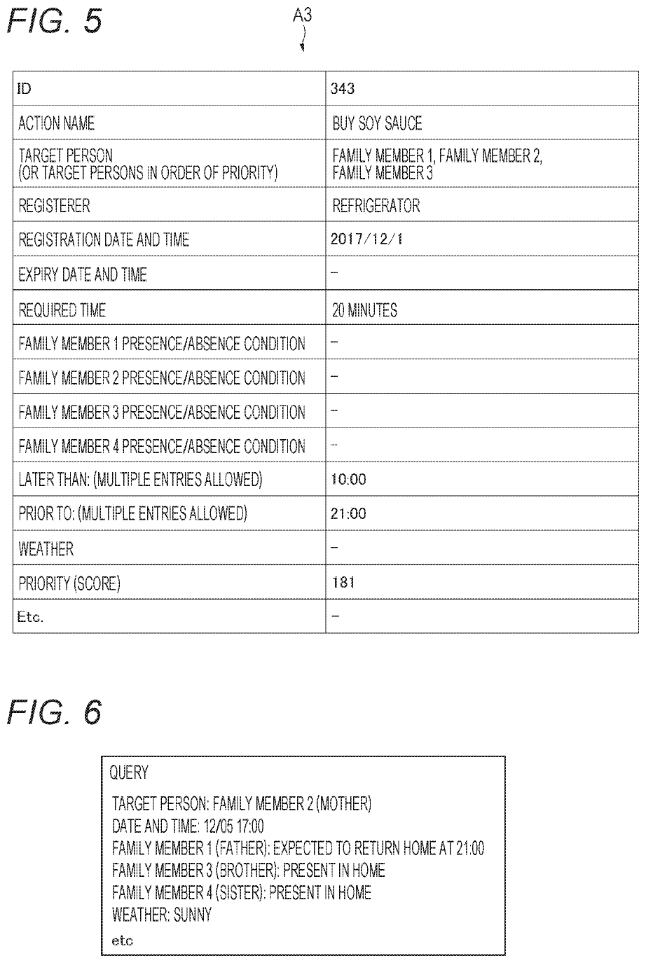

Note that the so-called Internet of things (IoT) apparatuses, which are the things previously not connected to networks but nowadays connected to other apparatuses via networks, have been drawing attention in recent years. The external apparatus 30 according to the present embodiment may be any of such IoT apparatuses. The external apparatus 30 in the present example is a refrigerator, which is an example of IoT apparatuses. FIG. 5 shows the action information (action information A3) registered on the basis of information obtained from the refrigerator. The refrigerator senses the contents of the refrigerator itself using a sensor device such as an imaging device to check for missing items. In the present example, soy sauce is recognized as a missing item, and the missing item information is sent to the server device 20.

The server control unit 201 registers the action information A3 that has the action attribute whose action name is buy soy sauce, from the missing item information received via the server communication unit 204. The required time is calculated on the basis of the position information regarding the home and the position information regarding a supermarket. The time to perform the action is set on the basis of, for example, the business hours of the supermarket, the business hours being obtained by the server device 20 by accessing the home page of the supermarket. Note that buying soy sauce may be given a higher priority, which is one of action attributes, in order that the server control unit 201 recognizes that soy sauce is often used for cooking and the like, so that soy sauce is immediately replenished, or in other words, so that an action of buying soy sauce is immediately presented as a recommended action.

(Example of Retrieval of Action Information)

The following describes examples of retrieval of action information with reference to FIGS. 6 to 9. FIG. 6 shows an example of a query generated by the database processing unit 201b of the server control unit 201. For example, the context recognition unit 201a recognizes, on the basis of the information supplied from the agent 10, that the family member 2 (mother), the family member 3 (brother), and the family member 4 (sister) are present in the home as the contexts of the mother, brother, and sister. In addition, on the basis of, for example, the timekeeping function of the server device 20, the context recognition unit 201a recognizes that the user UA is present in the home at the current date and time of 12/5, 17:00 as the context. Note that the time information may be supplied from the service providing device 40.

Moreover, on the basis of the position information regarding the smartphone owned by the family member 1 (father) and of the father's usual times to return home, the context recognition unit 201a recognizes the context of the family member 1 (father) by estimating that the father is expected to return home at 21:00. Furthermore, the context recognition unit 201a recognizes the day's weather (sunny) as a context on the basis of information supplied from the service providing device 40. The context recognition unit 201a supplies the recognized contexts to the database processing unit 201b. The database processing unit 201b generates the query shown in FIG. 6 on the basis of the supplied contexts.

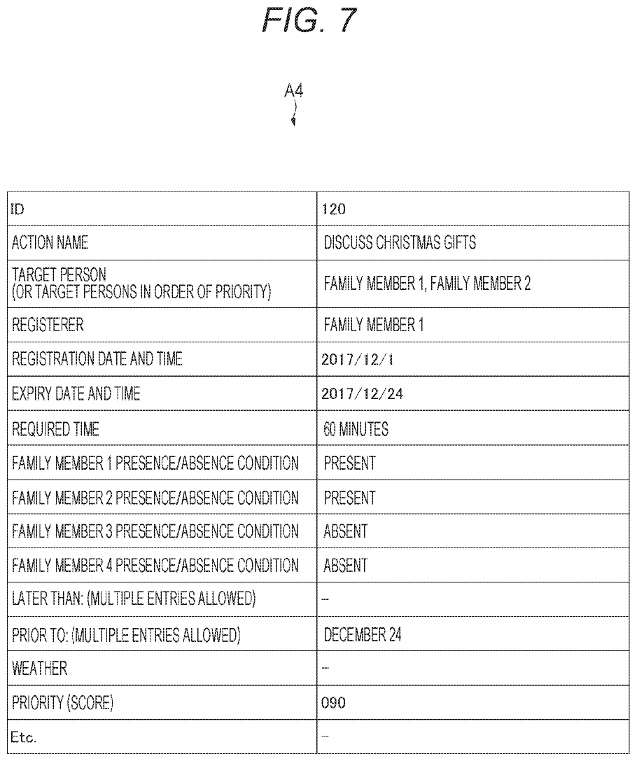

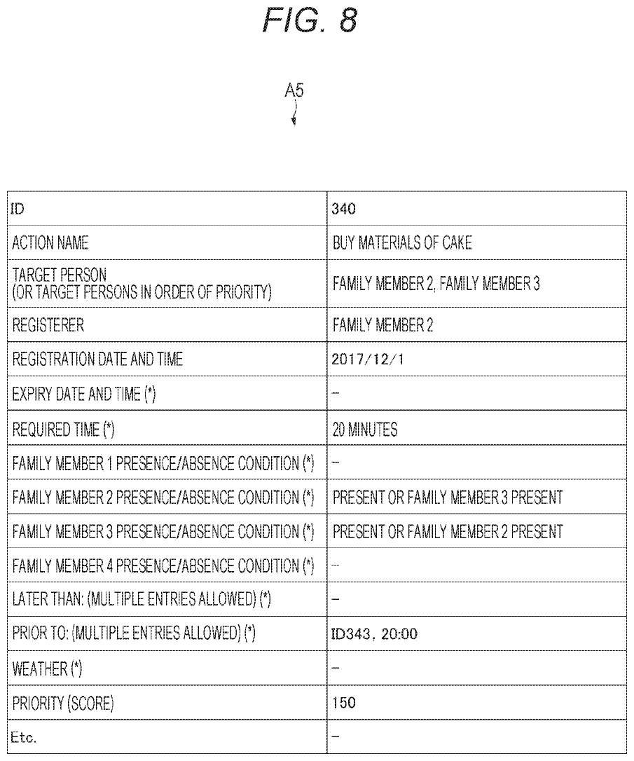

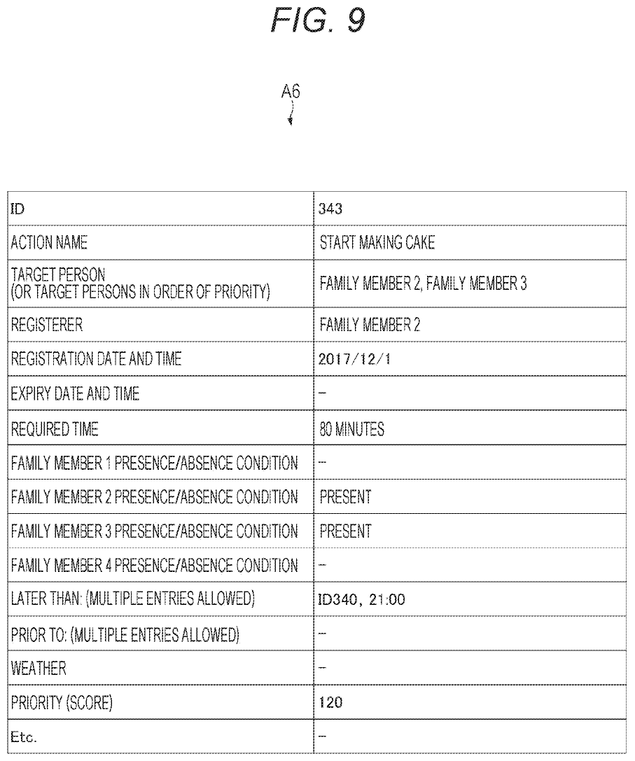

FIG. 7 shows the action information A4 stored in the action DB 202, FIG. 8 shows the action information A5 stored in the action DB 202, and FIG. 9 shows the action information A6 stored in the action DB 202.

The following describes examples of retrieval of an action to be recommended from the action information pieces A4 to A6 on the basis of the query shown in FIG. 6. The action information A4 is not retrieved as a recommended action because the action information A4 has the family member 1 (father) included in target persons. The action information pieces A5 and A6 match the conditions described in the query. In this case, the action information A5, which has a higher priority (a higher numerical value of the priority), is preferentially extracted. Note that, if a plurality of action information pieces is found, the action information having a smaller ID (the one registered earlier) may be preferentially extracted. Consequently, the database processing unit 201b determines that the action information A5 is the recommended action to be presented to the mother.

[Process flow]

(Process Flow for Manually Registering Action Information)

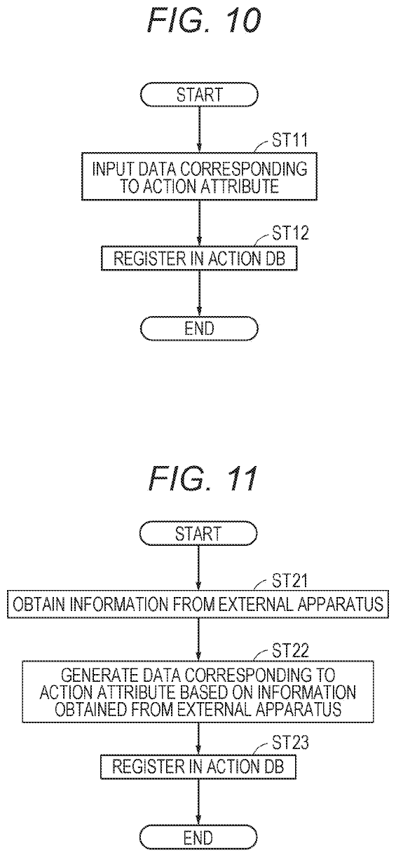

FIG. 10 is a flowchart showing a process flow for manually registering action information. In step ST11, the user inputs data corresponding to an action attribute. This operation is performed by, for example, using the input unit 105. The agent control unit 101 generates data corresponding to the input operation on the input unit 105, and transmits the data to the server communication unit 204 via the agent communication unit 104. The data received by the server communication unit 204 is supplied to the server control unit 201. Then, the processing proceeds to step ST12.

In step ST12, the database processing unit 201b of the server control unit 201 writes data corresponding to each of action attributes to the action DB 202 in accordance with the data transmitted from the agent 10, and registers the action information including these action attributes in the action DB 202. Then, the process is finished. Note that a similar process is performed in a case where the contents of the action information are changed manually.

(Process Flow for Automatically Registering Action Information)

FIG. 11 is a flowchart showing a process flow for automatically registering action information. In step ST21, information is supplied from the external apparatus 30 to the server device 20. The contents of the information differ depending on the type of the external apparatus 30. Note that the server device 20 may request information from the external apparatus 30, or the external apparatus 30 may periodically supply information to the server device 20. Alternatively, the service providing device 40 instead of the external apparatus 30 may provide information to the server device 20. The information supplied from the external apparatus 30 is supplied to the server control unit 201 via the server communication unit 204. Then, the processing proceeds to step ST22.

In step ST22, the database processing unit 201b generates data corresponding to an action attribute on the basis of the information obtained from the external apparatus 30. Then, the processing proceeds to step ST23.

In step ST23, the database processing unit 201b writes the generated data corresponding to each of action attributes to the action DB 202, and registers the action information including these action attributes in the action DB 202. Then, the process is finished. A similar process is performed in a case where the contents of the action information are automatically changed in accordance with the information from the external apparatus 30 or the service providing device 40. Note that the action information can be manually updated, and may further be automatically updated.

(Process Flow for Outputting Recommended Action)

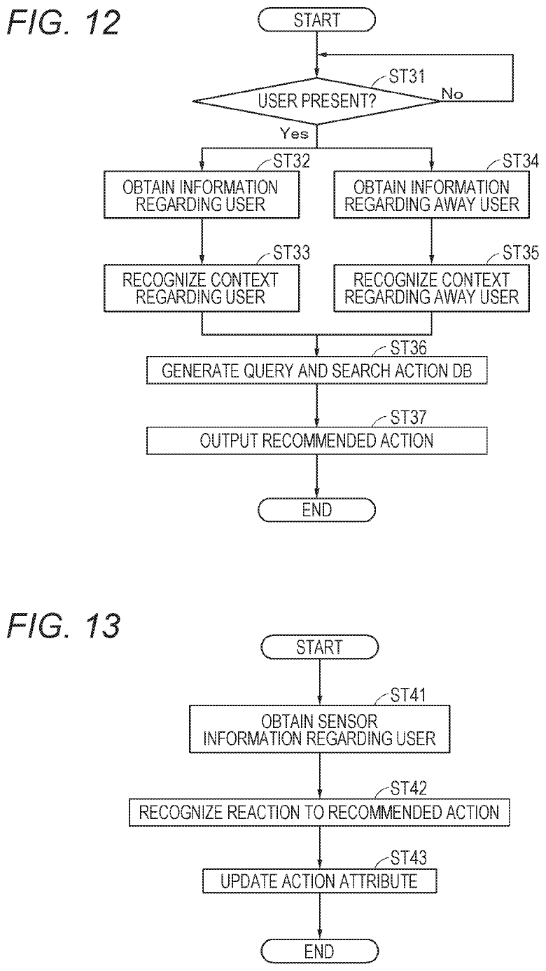

FIG. 12 is a flowchart showing a process flow for outputting a recommended action. In step ST31, it is determined whether or not the user UA is present in a predetermined place, or in the home, for example. In this process step, the determination is made by the agent control unit 101 on the basis of the sensing result provided by the agent sensor unit 102. If the user UA is not present in the home, the processing returns to step ST31. If the user UA is present in the home, the agent control unit 101 transmits the information indicating that the user UA is present in the home and who the user UA is to the server device 20 via the agent communication unit 104. Then, the information is received by the server communication unit 204. Note that he following description is given assuming that the user UA present in the home is the mother in the family. The processing proceeds to step ST32 and subsequent steps.

The processing in steps ST32 to ST36 is performed by, for example, the server control unit 201 in the server device 20. Note that the processing in steps ST32 and ST33 and the processing in steps ST34 and ST35 may be performed in time series or may be performed in parallel.

In step ST32, information regarding the user UA is acquired. For example, the information transmitted from the agent 10 indicating that the mother is present in the home is supplied from the server communication unit 204 to the server control unit 201. Then, the processing proceeds to step ST33.

In step ST33, the context recognition unit 201a recognizes the context regarding the user UA. In the present example, the context recognition unit 201a recognizes the context regarding the mother, for example, that the mother is present in the home as of 15:00. Then, the context recognition unit 201a supplies the recognized context to the database processing unit 201b.

On the other hand, in step ST34, the server control unit 201 acquires information regarding the away user UB. For example, the server control unit 201 acquires, via the server communication unit 204, the position information regarding the smartphone, which is one of the external apparatuses 30 and is owned by the away user UB (father, for example). Then, the processing proceeds to step ST35.

In step ST35, the context recognition unit 201a recognizes the context regarding the father. For example, from the change in the position information regarding the smartphone of the father, the context recognition unit 201a recognizes that the father has started an action of heading for the home and, on the basis of his current position, the position of the home, the moving speed of the father, and the like, the context recognition unit 201a recognizes the father's context including at least the estimated time at which the father is expected to arrive at the home. Note that the context recognition unit 201a may recognize the context including the estimated time of returning home by referring to the log of times of returning home (for example, the log of times of returning home by day of week) stored in the memory (not illustrated) in the server device 20 without using the external apparatus 30. The context recognition unit 201a outputs the recognized context regarding the father (for example, the context that the father will return home at 19:00) to the database processing unit 201b. Then, the processing proceeds to step ST36.

In step ST36, the database processing unit 201b generates a query. For example, a query including the target person (mother) to whom a recommended action is to be presented, the current time 15:00, and the estimated time 19:00 at which the father is expected to return home is generated. Then, the database processing unit 201b searches the action DB 202 on the basis of the generated query, and extracts a recommended action to be presented to the mother from a plurality of actions stored in the action DB 202. For example, the database processing unit 201b identifies actions to be performed by 19:00 when the father returns home (for example, viewing a recorded program by 17:00, preparing supper from 17:00, and so on) as recommended actions. As a matter of course, an action to be performed after the time when the father is expected to return home may be recommended. The result of retrieval by the database processing unit 201b, that is, the data corresponding to a recommended action, is transmitted to the agent 10 via the server communication unit 204 under the control of the server control unit 201. Then, the processing proceeds to step ST37.

In step ST37, the recommended action is presented to the user UA (the mother in the present example) present in the home. For example, the data corresponding to the recommended action transmitted from the server device 20 is supplied to the agent control unit 101 via the agent communication unit 104. The agent control unit 101 converts the data into data in a format compatible with the recommended action output unit 103, and then supplies the converted data to the recommended action output unit 103. Then, the recommended action output unit 103 presents the recommended action to the mother by, for example, displaying the recommended action. As a result of the above-described processing, a recommended action is presented to the mother. Note that, in the processing described above, the context recognition unit 201a may recognize a context on the basis of information obtained from an external apparatus, and a query may be generated on the basis of a context that includes the recognized context. Then, a recommended action may be retrieved on the basis of the query.

The mother presented with a recommended action as described above may or may not perform the recommended action. Furthermore, once a recommended action is presented, the data indicating the action information corresponding to the recommended action may be deleted from the action DB 202 or may be stored as the data to be referred to when an action attribute included in other action information is updated. Alternatively, the data indicating the action information corresponding to the recommended action may be allowed to be deleted from the action DB 202 only when it is detected that the presented recommended action has been performed on the basis of the result of sensing by the agent sensor unit 102.

(Example in which Action Attribute in Action DB is Updated on the Basis of Action Performed in Response to Presentation of Recommended Action)

In the present embodiment, an action attribute in the action DB 202 is updated on the basis of an action performed in response to presentation of a recommended action. FIG. 13 is a flowchart showing a process flow for the updating.

In step ST41, the sensor information regarding the user UA present in the home (for example, in the living room) is obtained. The sensor information is, for example, image data acquired by the agent sensor unit 102. The agent control unit 101 transmits the image data to the server device 20 via the agent communication unit 104. The image data is received by the server communication unit 204, and supplied to the server control unit 201. Then, the processing proceeds to step ST42.

In step ST42, the server control unit 201 recognizes a reaction corresponding to the recommended action on the basis of the image data. Then, the processing proceeds to step ST43.

In step ST43, the database processing unit 201b updates an action attribute in the predetermined action information on the basis of the result of recognition of the reaction corresponding to the recommended action.

The following describes specific examples.

### Specific Example 1

“Example Recognition of Reaction to Recommended Action”

. . . The recommended action “Play recorded program” is presented to the mother. The mother performs the presented recommended action by playing the recorded program. At this time, not only the mother but also the brother and sister are detected viewing the recorded program with the mother by the agent sensor unit 102.

“Example of Updating”

. . . It is determined that not only the mother but also the brother and sister are interested in the same program as the recorded program. Therefore, in addition to the mother, the brother and sister are added to the action attribute (for example, the target person) in the action information in which an action of viewing the same program as the recorded program is defined as an action attribute.

### Specific Example 2

“Example Recognition of Reaction to Recommended Action”

. . . When only the mother is present in the home, a recommended action of vacuuming is presented to the mother. The mother performs the presented recommended action by vacuuming. At this time, the vacuuming having been finished in a shorter time than a usual required time is detected by the agent sensor unit 102.

“Example of Updating”

. . . The action information including vacuuming as an action attribute is updated so that the action attribute (the target person) is the mother, the action attribute (presence/absence condition) is absence except the mother, and the action attribute (required time) is a shorter time.

### Specific Example 3

“Example Recognition of Reaction to Recommended Action”

Viewing a move at home is presented to all the family members as a recommended action. The family members perform the presented recommended action by viewing a movie. At this time, the agent sensor unit 102 detects that the family members do not leave the home (for example, the living room) for about 30 minutes after viewing the movie.

“Example of Updating”

. . . The server control unit 201 determines that the family members together have a happy family time for about 30 minutes after viewing a movie. Therefore, the server control unit 201 updates the action information including an action of viewing a movie by adding 30 minutes to the action attribute (required time) so as to suppress the following recommendation of an action.

As described above, updating an attribute in the action DB 202 on the basis of an action that has been performed in response to a presented recommended action makes it possible to recommend an action with much higher time efficiency.

[Output Example of Recommended Action]

The following describes examples of recommended actions output by the recommended action output unit 103. As described above, in the present embodiment, a recommended action is output to the target person by displaying the recommended action.

### First Example

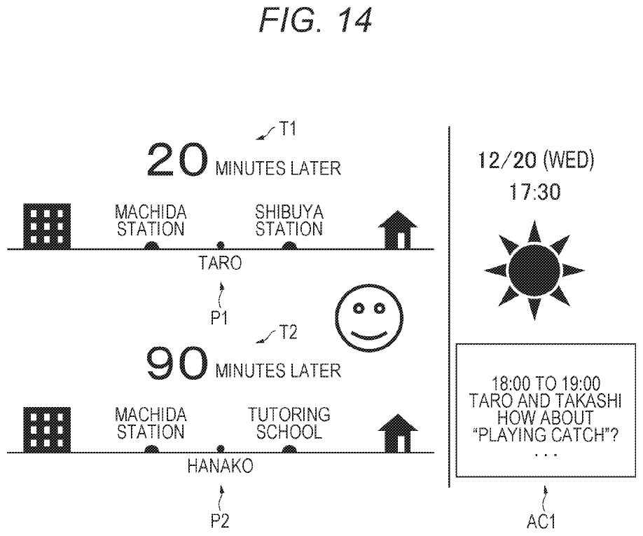

FIG. 14 is an example of a displayed recommended action (first example). FIG. 14 shows an example of a recommended action recommended to Takashi. On the left side of the display, there are displayed the current position P1 and the estimated time of returning home T1 of Taro, who is Takashi's father. Note that, as shown in FIG. 14, the estimated time of returning home may be a time relative to the current time (which is 17:30 appearing on the right in the example shown in FIG. 14) instead of an exact time. That is, in the present example, the phrase “20 minutes later” is shown as the estimated time of returning home T1, indicating that Taro will return home 20 minutes later. Furthermore, the current position P2 and the estimated time of returning home T2 (90 minutes later) of Hanako, who is Takashi's sister and shown as an example of another family member are displayed. In addition, on the right side of the screen, there is displayed a recommended action AC1 of playing catch for one hour (18:00 to 19:00) after Taro returns home. Note that the estimated time of returning home is highlighted compared with other displayed items in the present example.

### Second Example

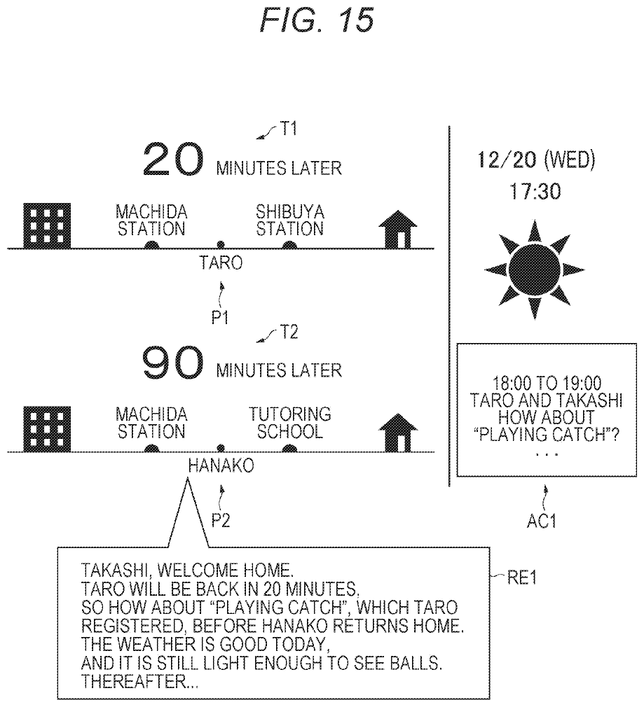

FIG. 15 is an example of a displayed recommended action (second example). The second example is a modification of the first example. A recommended action may be displayed along with, for example, a reason why the recommended action is recommended. For example, the example shown in FIG. 15 displays at the bottom of the screen a reason RE1 why the recommended action is recommended. The reason RE1 includes, for example, the estimated time when a family member is expected to return home, the date and time, and the weather. Displaying the reason RE1 in this way makes it possible to make the user more convinced and to give the user an incentive to perform the recommended action.

### Third Example

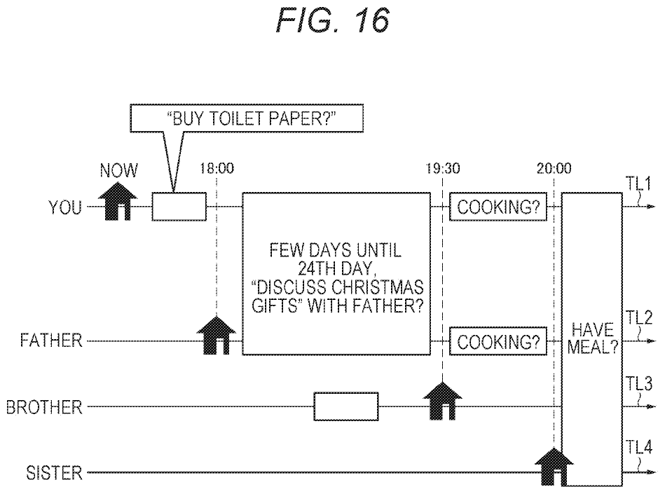

FIG. 16 is an example of a displayed recommended action (third example). For example, a timeline TL1 is shown next to the display item indicating the target person (You, that is, mother) of the recommended action. Timelines TL2, TL3, and TL4 are similarly shown for the other family members (father, brother, and sister). A recommended action may be displayed on a timeline. In the example shown in FIG. 16, “Buy toilet paper” is displayed as a recommended action for the mother to perform between the current time and 18:00. In a case where a recommended action involves a plurality of persons, the recommended action is displayed across the timelines of the related target persons. In the example shown in FIG. 15, the action “Discuss gifts” is displayed, as a recommended action, across both the timeline TL1 corresponding to the mother and the timeline TL2 corresponding to the father. A recommended action can be displayed on a timeline in this way, whereby the user can intuitively recognize the time to perform the recommended action.

### Fourth Example

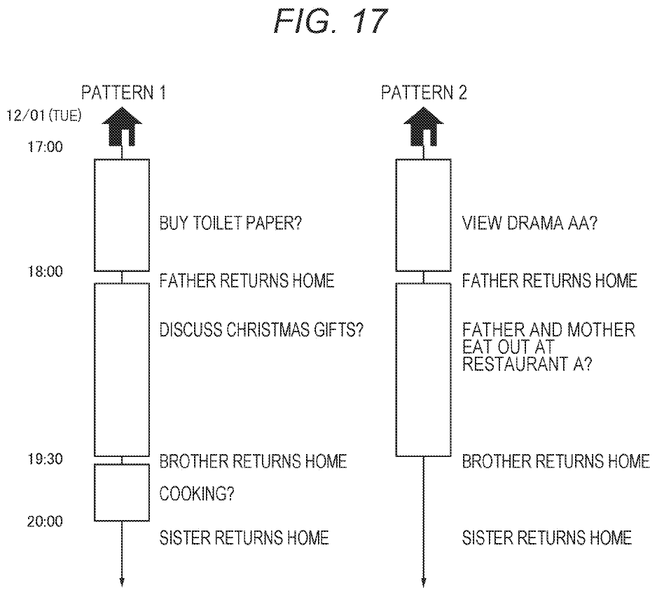

FIG. 17 is an example of a displayed recommended action (fourth example). When a plurality of recommended actions is retrieved, the plurality of recommended actions may be displayed. In FIG. 17, recommended actions in a certain pattern (pattern 1) and recommended actions in another pattern (pattern 2) are displayed side by side. Recommended actions in three or more patterns may be displayed. In a case where a plurality of recommended actions is displayed, a recommended action to be displayed may be switched among the recommended actions in response to a user operation. Then, only the recommended action selected by the user UA from the plurality of recommended actions may be allowed to be displayed.

(Example of Trigger for Outputting Recommended Action)

The following describes examples of a trigger (condition) for outputting a recommended action. Examples of the trigger include a question asked by the user UA. For example, the user UA gives an utterance asking for presentation of a recommended action to the agent 10. The agent 10 recognizes, through speech recognition of the utterance, that presentation of a recommended action has been requested, and then presents a recommended action.

A recommended action may be presented in a case where the agent sensor unit 102 detects the presence of the user UA. For example, in a case where the agent sensor unit 102 detects that the user UA has returned home from a location away from the home and is now present, a recommended action may be presented to the user UA. Furthermore, in a case where the away user UB is detected performing an action of returning home, a recommended action may be presented to the user UA. Furthermore, a recommended action may be presented to the user UA at the timing when the agent 10 (which may be a device having the functions of the agent 10) is powered on.

### 2. Modifications

The foregoing has described one embodiment of the present disclosure in detail, but the contents of the present disclosure are not limited to the above-described embodiment, and various modifications can be made thereto on the basis of the technical idea of the present disclosure. Modifications are described below.

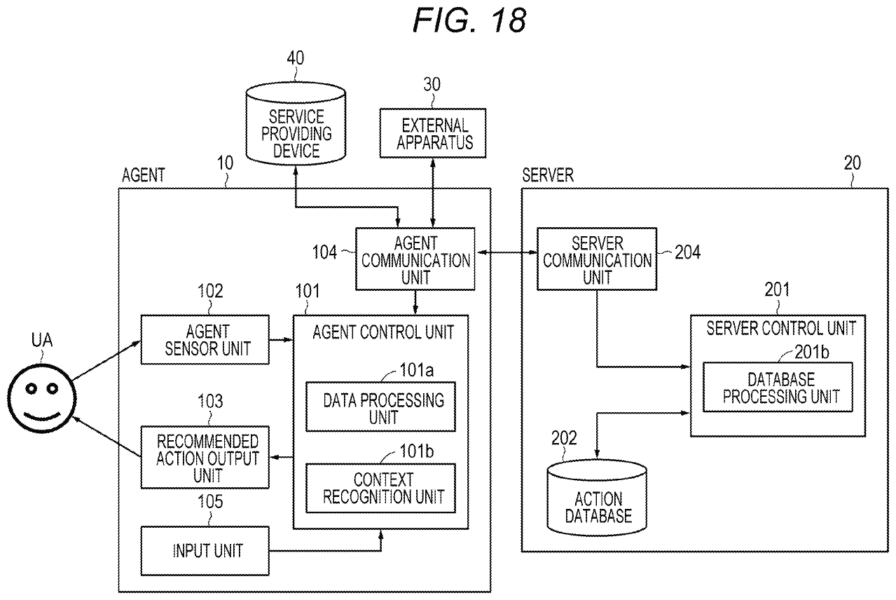

The configuration of the information processing system 1 can be modified as appropriate in terms of which device has the functions described above. For example, the functions of the context recognition unit 201a described above may be included in the agent 10. Specifically, as shown in FIG. 18, the agent 10 may include a context recognition unit 101b that performs a function similar to the function of the context recognition unit 201a.

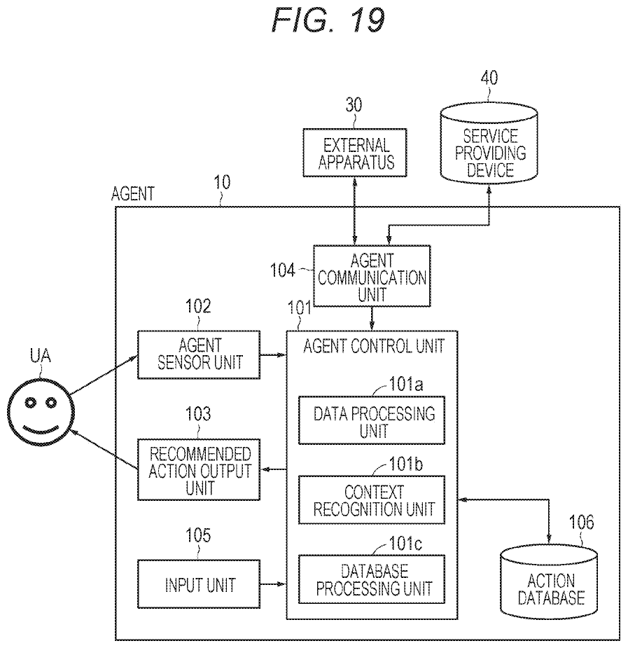

Alternatively, the agent 10 may be configured to perform all the processes described in the one embodiment. For example, as illustrated in FIG. 19, the agent 10 may include: a context recognition unit 101b that performs a function similar to the function of the context recognition unit 201a; a database processing unit 101c that performs a function similar to the function of the database processing unit 201b; and an action DB 106 that stores data similar to the data stored in the action DB 202. In the case of the configuration illustrated in each of FIGS. 18 and 19, the agent 10 may serve as an information processing device.

In the above-described one embodiment, the agent sensor unit 102 is configured to detect that the user UA is present in the home. However, the presence of the user UA in the home may be detected on the basis of the position information regarding the smartphone owned by the user UA.

In the above-described one embodiment, the predetermined place is the home, but the predetermined place is not limited thereto. The predetermined place may be a company or a restaurant. For example, on the basis of the time when the boss is expected to arrive at the company, an action of preparing documents can be presented to a subordinate as a recommended action. Furthermore, on the basis of the time when a friend of the user is expected to arrive at a restaurant, an action of ordering food and drink for the friend can be presented to the user present in the restaurant as a recommended action.

If the time when the away user UB in an action of returning home is expected to come home is changed due to shopping, stopover, traffic problem, or the like, the server control unit 201 may recalculate the estimated time when the away user UB is expected to return home and present a recommended action based on the recalculated estimated time of returning home.

The agent sensor unit 102 may be any sensor as long as it can detect whether or not the user UA is present in a predetermined place (the home, in the embodiment). The agent sensor unit 102 is not limited to an imaging device but may be a sound sensor that detects the presence of the user UA on the basis of any voice, an illuminance sensor that detects the presence of the user UA on the basis of illuminance, a temperature sensor that detects the presence of the user UA by detecting the body temperature of the user UA, or the like. Furthermore, the presence of the user UA may be detected in accordance with a result of wireless communication between a portable apparatus such as the smartphone owned by the user UA and an apparatus (a home server, for example) in the home. Examples of the wireless communication include a local area network (LAN), Bluetooth (registered trademark), Wi-Fi (registered trademark), or wireless USB (WUSB).

The agent 10 in the above-described one embodiment does not necessarily need to be an independent apparatus by itself, and a function of the agent 10 may be incorporated into another apparatus. For example, a function of the agent 10 may be incorporated into a television device, a sound bar, a lighting device, a refrigerator, an in-vehicle device, or the like.

Some of the components of the agent 10 may be separated from the agent 10. For example, in a case where the recommended action output unit 103 is a display, the recommended action output unit 103 may be a display of a television device separate from the agent 10. Alternatively, the recommended action output unit 103 may be an audio output device such as a speaker or a headphone.

Recommended actions may include an omission of performing a specific action, that is, resting rather than performing an action by the target person. For example, suppose that known image recognition is performed on the basis of image data obtained by the agent sensor unit 102, and it is detected that the user UA is in a fatigued state. Also suppose that the away user UB is expected to return home far later than the current time (for example, several hours later). In such cases, “resting” may be presented as a recommended action.

The action DB 202 is not limited to, for example, a magnetic storage device such as a hard disk drive (HDD) but may include a semiconductor storage device, an optical storage device, a magneto-optical storage device, or the like.

When the agent sensor unit 102 is detecting the presence of the user UA in a predetermined place, the user UA may temporarily leave the place. For example, in a case where the predetermined place is the living room in the home, the user UA may leave the living room for going to the toilet or the like. In anticipation of such cases, the agent control unit 101 may determine, during a certain period of time, that the user UA is present in the living room even when the user UA is not detected. Then, when the user UA is not detected in the living room for a certain period of time, the agent control unit 101 may determine that the user UA has become absent, and then, when the presence of the user UA in the living room is detected, the processing described in one embodiment may be performed.

The configuration described in the above one embodiment is merely an example and is not restrictive. Needless to say, additions, deletions, and the like may be made to and from the configuration without departing from the spirit of the present disclosure. The present disclosure can also be implemented in any form such as an apparatus, a method, a program, and a system.

The present disclosure may have the following configurations.

(1)

An information processing device including:

a control unit that determines a recommended action to be presented to a user being present in a predetermined place, the recommended action being determined on the basis of a first context of the user and a second context of an away user, the second context including information regarding a time at which the away user heading for the place is expected to arrive at the place.

(2)

The information processing device according to (1), in which

the control unit includes a context recognition unit that recognizes the first context and the second context.

(3)

The information processing device according to (2), in which

the context recognition unit recognizes a third context that is different from the first context and from the second context, and

the control unit determines the recommended action on the basis of the first context, the second context, and the third context.

(4)

The information processing device according to any one of (1) to (3), in which

the first context includes presence of the user in the predetermined place.

(5)

The information processing device according to any one of (2) to (4), further including:

a search unit that sets a search condition on the basis of a result of recognition by the context recognition unit, and retrieves the recommended action on the basis of the search condition from a storage unit that stores a plurality of action information pieces.

(6)

The information processing device according to any one of (1) to (5), further including:

an output unit that outputs the recommended action determined by the control unit.

(7)

The information processing device according to (6), in which

the output unit outputs the recommended action in response to a predetermined trigger.

(8)

The information processing device according to (7), in which

the predetermined trigger is any one of: a case where the away user is detected heading for the place; a case where the information processing device is activated; a case where a request for outputting the recommended action is made by the user; and a case where the presence of the user in the predetermined place is detected.

(9)

The information processing device according to any one of (1) to (8), in which

in a case where a plurality of the recommended actions is obtained, the control unit determines the recommended action to be presented to the user in accordance with priority.

(10)

The information processing device according to (5), in which

contents of the plurality of action information pieces stored in the storage unit are automatically updated.

The information processing device according to (10), in which

the contents of the plurality of action information pieces stored in the storage unit are automatically updated on the basis of information from an external apparatus.

(12)

The information processing device according to (10) or (11), in which

the contents of the plurality of action information pieces stored in the storage unit are automatically updated on the basis of an action performed in response to presentation of the recommended action.

(13)

The information processing device according to any one of (5) and (10) to (12), in which

the storage unit stores the plurality of action information pieces in which chronological relationships among the action information pieces are set.

(14)

The information processing device according to any one of (6) to (8), in which

the output unit includes a display unit that outputs the recommended action by displaying the recommended action.

(15)

The information processing device according to (14), in which

the recommended action is displayed along with a timeline on the display unit.

(16)

The information processing device according to (14), in which

the recommended action is displayed along with a reason for recommendation on the display unit.

(17)

The information processing device according to (14), in which

a plurality of the recommended actions is displayed on the display unit.

(18)

The information processing device according to any one of (1) to (17), in which

the predetermined place is a range that a predetermined sensor device is capable of sensing.

(19)

An information processing method including:

determining a recommended action to be presented to a user being present in a predetermined place, the recommended action being determined on the basis of a first context of the user and a second context of an away user, the second context including information regarding a time at which the away user heading for the place is expected to arrive at the place, the determining being performed by a control unit.

(20)

A program causing a computer to execute an information processing method, the information processing method including:

determining a recommended action to be presented to a user being present in a predetermined place, the recommended action being determined on the basis of a first context of the user and a second context of an away user, the second context including information regarding a time at which the away user heading for the place is expected to arrive at the place, the determining being performed by a control unit.

### REFERENCE SIGNS LIST

1 Information processing system
10 Agent
20 Server device
30 External apparatus
40 Service providing device 40
101 Agent control unit
102 Agent sensor unit
103 Recommended action output unit
201 Server control unit
201a Context recognition unit
201b Database processing unit
202 Action database

1. An information processing device comprising:
a control unit that determines a recommended action to be presented to a user being present in a predetermined place, the recommended action being determined on a basis of a first context of the user and a second context of an away user, the second context including information regarding a time at which the away user heading for the place is expected to arrive at the place.

2. The information processing device according to claim 1, wherein
the control unit includes a context recognition unit that recognizes the first context and the second context.

3. The information processing device according to claim 2, wherein
the context recognition unit recognizes a third context that is different from the first context and from the second context, and
the control unit determines the recommended action on a basis of the first context, the second context, and the third context.

4. The information processing device according to claim 1, wherein
the first context includes presence of the user in the predetermined place.

5. The information processing device according to claim 2, further comprising:
a search unit that sets a search condition on a basis of a result of recognition by the context recognition unit, and retrieves the recommended action on a basis of the search condition from a storage unit that stores a plurality of action information pieces.

6. The information processing device according to claim 1, further comprising:
an output unit that outputs the recommended action determined by the control unit.

7. The information processing device according to claim 6, wherein
the output unit outputs the recommended action in response to a predetermined trigger.

8. The information processing device according to claim 7, wherein
the predetermined trigger is any one of: a case where the away user is detected heading for the place; a case where the information processing device is activated; a case where a request for outputting the recommended action is made by the user; and a case where the presence of the user in the predetermined place is detected.

9. The information processing device according to claim 1, wherein
in a case where a plurality of the recommended actions is obtained, the control unit determines the recommended action to be presented to the user in accordance with priority.

10. The information processing device according to claim 5, wherein
contents of the plurality of action information pieces stored in the storage unit are automatically updated.

11. The information processing device according to claim 10, wherein
the contents of the plurality of action information pieces stored in the storage unit are automatically updated on a basis of information from an external apparatus.

12. The information processing device according to claim 10, wherein
the contents of the plurality of action information pieces stored in the storage unit are automatically updated on a basis of an action performed in response to presentation of the recommended action.

13. The information processing device according to claim 5, wherein
the storage unit stores the plurality of action information pieces in which chronological relationships among the action information pieces are set.

14. The information processing device according to claim 6, wherein
the output unit includes a display unit that outputs the recommended action by displaying the recommended action.

15. The information processing device according to claim 14, wherein
the recommended action is displayed along with a timeline on the display unit.

16. The information processing device according to claim 14, wherein
the recommended action is displayed along with a reason for recommendation on the display unit.

17. The information processing device according to claim 14, wherein
a plurality of the recommended actions is displayed on the display unit.

18. The information processing device according to claim 1, wherein
the predetermined place is a range that a predetermined sensor device is capable of sensing.

19. An information processing method comprising:
determining a recommended action to be presented to a user being present in a predetermined place, the recommended action being determined on a basis of a first context of the user and a second context of an away user, the second context including information regarding a time at which the away user heading for the place is expected to arrive at the place, the determining being performed by a control unit.

20. A program causing a computer to execute an information processing method, the information processing method comprising:
determining a recommended action to be presented to a user being present in a predetermined place, the recommended action being determined on a basis of a first context of the user and a second context of an away user, the second context including information regarding a time at which the away user heading for the place is expected to arrive at the place, the determining being performed by a control unit.
